(19) United States
(12) Patent Application Publication
(10) Pub. No.: US 2018/0367094 A1
(43) Pub. Date: Dec. 20, 2018

(54) PHOTOVOLTAIC MODULE UNIT AND PHOTOVOLTAIC DEVICE

(71) Applicant: BEIJING APOLLO DING RONG SOLAR TECHNOLOGY CO., LTD, Beijing (CN)

(72) Inventors: Hejiang LV, Beijing (CN); Wei JIANG, Beijing (CN); Hong WANG, Beijing (CN); Xueliang ZHANG, Beijing (CN); Weibin QI, Beijing (CN); Junrong LIN, Beijing (CN)

(73) Assignee: BEIJING APOLLO DING RONG SOLAR TECHNOLOGY CO., LTD, Beijing (CN)

(21) Appl. No.: 16/112,758

(22) Filed: Aug. 26, 2018

Related U.S. Application Data
(63) Continuation-in-part of application No. PCT/CN2017/113238, filed on Nov. 28, 2017.

(30) Foreign Application Priority Data
Oct. 13, 2017 (CN) 201721320066.4

(51) Int. Cl. H02S 30/10; H02S 20/10; H02S 40/00

(52) U.S. Cl. CPC H02S 30/10; H02S 40/00; H02S 20/10

(57) ABSTRACT

This embodiment discloses a photovoltaic module unit and a photovoltaic device. The photovoltaic module unit includes: a support frame, whose side face is provided with a lapping portion; a photovoltaic module, two ends of which are lapped at the lapping portion; and load-bearing glass, bottom faces at two ends of the load-bearing glass being fixed to a top of the support frame. A preset clearance is provided between the load-bearing glass and the photovoltaic module. In the photovoltaic module unit and the photovoltaic device provided by this embodiment, the support frame is arranged to be supported on a road surface and to support the photovoltaic module, and the load-bearing glass is arranged to protect and cover the photovoltaic module. The ground photovoltaic power generation module unit and the ground photovoltaic power generation module are low in installation cost, convenient for maintenance and time-saving, and can be installed in different roadbed conditions. The photovoltaic module may adopt a high-quality CIGS module. The ground photovoltaic power generation module unit and the ground photovoltaic power generation module are higher in power generation efficiency and shorter in cost recovery time and saving in land utilization, etc.

### CROSS-REFERENCE TO RELATED APPLICATIONS

This application is a continuation-in-part application of and claims the benefit and priority of Patent Application No. PCT/CN2017/113238, filed on Nov. 28, 2017, under the Patent Cooperation Treaty (PCT), which claims the benefit and priority of Patent Application No. 201721320066.4 filed in China on Oct. 13, 2019. The entire contents of both the PCT and the Chinese patent applications are incorporated herein in their entirety by reference.

### TECHNICAL FIELD

Embodiments of the present disclosure relate to solar photovoltaic technologies, and more particularly, to a photovoltaic module unit and a photovoltaic device.

### BACKGROUND

With the development of society, human need more and more energy, and thus pollution problems become increasingly severe and depletion of fossil energy is increasingly serious. Therefore, diversified supply of energy particularly clean and environment-friendly energy is of high importance.

Now, a large number of large-scale centralized power stations and small-scale distributed power stations have been built all over the world. An excess of photovoltaic power stations have been built in underdeveloped regions, where power demand is so small that some photovoltaic power stations need to be abandoned However, developed regions are unable to provide more installation space. These circumstances have limitation to the development of the photovoltaic power stations. However, the vast of superior road pavement is the new continent of the photovoltaic power plants because mounting solar power generation components on the road does not occupy additional land or space.

### SUMMARY

This embodiment provides a photovoltaic module unit and a photovoltaic device to expand application space of photovoltaic power generation technologies on road pavement.

This embodiment provides a photovoltaic module unit, which includes a photovoltaic module, a light-transmitting load-bearing member, and a support frame. The support frame is used for supporting the photovoltaic module and the light-transmitting load-bearing member. The support frame includes a first supporting plane and a second supporting plane. The first supporting plane is positioned above the second supporting plane, the light-transmitting load-bearing member is arranged on the first supporting plane, and the photovoltaic module is arranged on the second supporting plane.

In the aforementioned photovoltaic module unit, alternatively, the support frame includes a lapping portion arranged on a side face of the support frame, the first supporting plane is an upper surface of the support frame, and the second supporting plane is an upper surface of the lapping portion.

In the aforementioned photovoltaic module unit, alternatively, a preset clearance is provided between the light-transmitting load-bearing member and the photovoltaic module.

Alternatively, the aforementioned photovoltaic module unit further includes an I-shaped steel. A bottom end of the I-shaped steel is fixed to a cement road block, and a top of the I-shaped steel is fixedly connected to a bottom of the support frame.

In the aforementioned photovoltaic module unit, alternatively, a rubber pad is provided between the top of the I-shaped steel and a bottom bracket of the support frame.

In the aforementioned photovoltaic module unit, alternatively, the number of the I-shaped steels is two, the two I-shaped steels are perpendicular to one another, and a perpendicular intersection of the two I-shaped steels is fixedly connected by means of an angle iron and a fastener.

In the aforementioned photovoltaic module unit, alternatively, either of the I-shaped steels is provided with a wire passing hole.

In the aforementioned photovoltaic module unit, alternatively, the light-transmitting load-bearing member is load-bearing glass.

In the aforementioned photovoltaic module unit, alternatively, the load-bearing glass is double-glazed laminated antiskid glass.

In the aforementioned photovoltaic module unit, alternatively, the bottom faces at two ends of the load-bearing glass are bonded and fixed to the first supporting plane by means of a structural adhesive.

Alternatively, the aforementioned photovoltaic module unit further includes a protective side frame, which is arranged at two ends of the light-transmitting load-bearing member and the support frame. The protective side frame is fixedly connected to the support frame by means of a bolt.

In the aforementioned photovoltaic module unit, alternatively, the support frame is made of aluminum alloy. This embodiment also provides a photovoltaic device, which includes a plurality of photovoltaic module units provided by this embodiment. Adjacent photovoltaic module units are fixedly connected to one another. The photovoltaic module unit includes: a photovoltaic module, a light-transmitting load-bearing member, and a support frame. The support frame includes a first supporting plane and a second supporting plane. The first supporting plane is positioned above the second supporting plane. The light-transmitting load-bearing member is arranged on the first supporting plane. The photovoltaic module is arranged on the second supporting plane.

In the aforementioned photovoltaic device, alternatively, the support frame includes a lapping portion arranged on a side face of the support frame, the first supporting plane is an upper surface of the support frame, and the second supporting plane is an upper surface of the lapping portion.

In the aforementioned photovoltaic device, alternatively, a preset clearance is provided between the light-transmitting load-bearing member and the photovoltaic module.

Alternatively, the aforementioned photovoltaic device further includes an I-shaped steel. A bottom end of the I-shaped steel is fixed to a cement road block, and a top of the I-shaped steel is fixedly connected to a bottom of the support frame.

In the aforementioned photovoltaic device, alternatively, a rubber pad is provided between the top of the I-shaped steel and a bottom bracket of the support frame.

In the aforementioned photovoltaic device, alternatively, the number of the I-shaped steels is two, the two I-shaped steels are perpendicular to one another, and a perpendicular intersection of the two I-shaped steels is fixedly connected by means of an angle iron and a fastener.

In the aforementioned photovoltaic device, alternatively, the light-transmitting load-bearing member is double-glazed laminated antiskid glass.

Alternatively, the aforementioned photovoltaic device further includes a protective side frame, which is arranged at two ends of the light-transmitting load-bearing member and the support frame. The protective side frame is fixedly connected to the support frame by means of a bolt. In the photovoltaic module unit and the photovoltaic device provided by this embodiment, the support frame is arranged to be supported on a road surface and to support the photovoltaic module, and the load-bearing glass is arranged to protect and cover the photovoltaic module. The ground photovoltaic power generation module unit and the ground photovoltaic power generation module are low in installation cost, convenient for maintenance and time-saving, and can be installed in different roadbed conditions. The photovoltaic module may adopt a high-quality CIGS module. The ground photovoltaic power generation module unit and the ground photovoltaic power generation module are higher in power generation efficiency and shorter in cost recovery time and saving in land utilization, etc.

### BRIEF DESCRIPTION OF THE DRAWING

FIG. 1 is a schematic structural diagram of a photovoltaic module unit according to Embodiment I;

FIG. 2 is an enlarged view of an end in FIG. 1;

FIG. 3 is a state diagram showing a photovoltaic module unit installed on a cement road block according to Embodiment I;

FIG. 4 is a state diagram showing a photovoltaic module unit installed on a cement road block according to Embodiment II;

FIG. 5 is an enlarged view of Part A in FIG. 4; and

FIG. 6 is a structural top view of a photovoltaic device according to Embodiment II;

Reference numbers in the attached drawings:

Photovoltaic module unit 100; support frame 110; lapping portion 111; photovoltaic module 120; junction box 121; load-bearing glass 130; clearance 140; I-shaped steel 150; wire passing hole 151; protective side frame 160; angle iron 170; rubber pad 180; fastener 190; and cement road block 200.

### DETAILED DESCRIPTION OF THE EMBODIMENTS

Embodiments of the present disclosure are described in detail as below. Examples of the embodiments are as shown in drawings, in which same or similar reference numbers always represent same or similar elements or elements with same or similar functions. The embodiments described below with reference to the drawings are exemplary, just used for explaining the embodiments, not construed as limiting the embodiments.

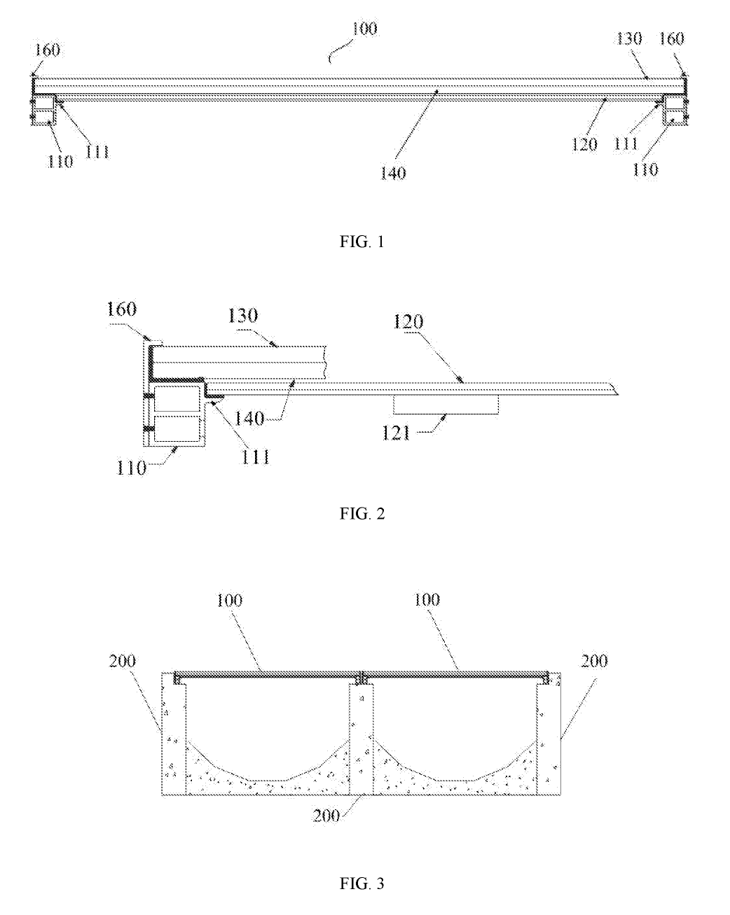

FIG. 1 is a schematic structural diagram of a photovoltaic module unit according to Embodiment I; FIG. 2 is an enlarged view of an end in FIG. 1; and FIG. 3 is a state diagram showing a photovoltaic module unit installed on a cement road block according to Embodiment I. As shown in FIG. 1-FIG. 3, this embodiment provides a photovoltaic module unit 100, which includes: a support frame 110, a photovoltaic module 120, and a light-transmitting load-bearing member 130. The support frame 110 is used for supporting the photovoltaic module 120 and the light-transmitting load-bearing member 130.

The support frame 110 is used for fixing to a cement road block 200, where a side face of the support frame 110 is provided with a lapping portion 111, which extends along the side face of the support frame 110. The support frame 110 has a first supporting plane and a second supporting plane. The first supporting plane is an upper surface of the support frame, and the second supporting plane is an upper surface of the lapping portion. The first supporting plane is positioned above the second supporting plane, the light-transmitting load-bearing member is arranged on the first supporting plane, and the photovoltaic module is arranged on the second supporting plane. Preferably the support frame 110 is made of aluminum alloy to implement light weight. Two ends of the photovoltaic module 120 are lapped at the lapping portion 111. Preferably, the photovoltaic module 120 is a double-glazed thin-film photovoltaic module, two ends of which are bonded to the lapping portion 111 by means of an adhesive. Preferably, the light-transmitting load-bearing member 130 is load-bearing glass, and further preferably is double-glazed laminated antiskid glass bottom faces at two ends of the light-transmitting load-bearing member 130 are fixed to a top of the support frame 110, preferably bonded and fixed to the first supporting plane of the support frame 110 by means of a structural adhesive. A preset clearance 140 is provided between the light-transmitting load-bearing member 130 and the photovoltaic module 120.

The photovoltaic module unit provided by this embodiment is supported on a road surface by means of the support frame 110 and supports the photovoltaic module 120. The light-transmitting load-bearing member 130 is arranged to protect and cover the photovoltaic module 120. The ground photovoltaic power generation module unit is low in installation cost, convenient for maintenance and time-saving, and can be installed in different roadbed conditions. The photovoltaic module 120 may adopt a high-quality CIGS module. The ground photovoltaic power generation module unit is higher in power generation efficiency and shorter in cost recovery time and saving in land utilization, etc.

Preferably, the photovoltaic module unit 100 further includes a protective side frame 160, which is arranged at two ends of the light-transmitting load-bearing member 130 and the support frame 110 and is fixedly connected to the support frame 110 by means of a bolt. The protective side frame 160 can protect the photovoltaic module 120 and the side face of the support frame 110 to prevent units from being damaged due to collision.

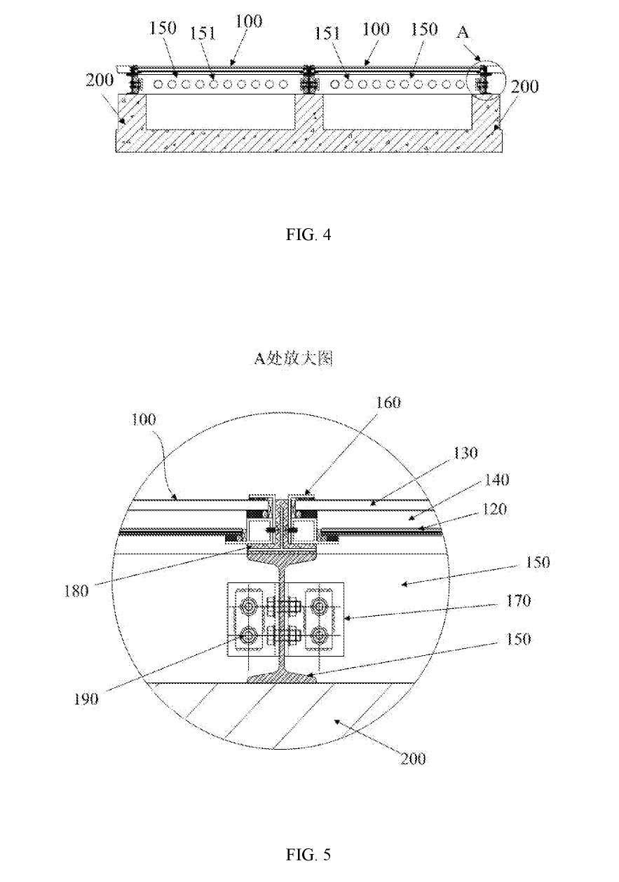

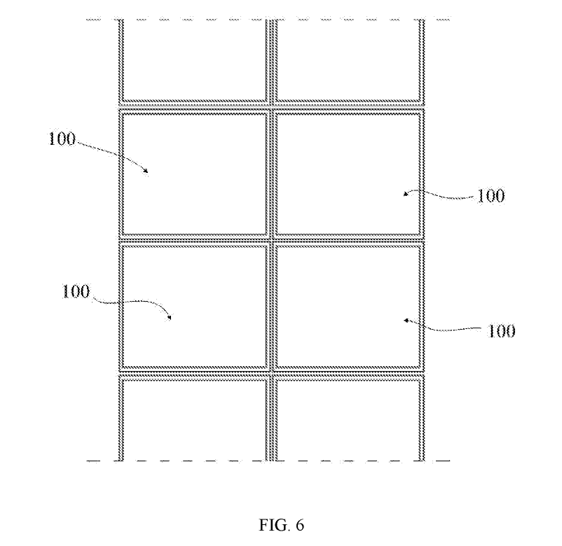

FIG. 4 is a state diagram showing a photovoltaic module unit installed on a cement road block according to an embodiment, and FIG. 5 is an enlarged view of Part A in FIG. 4.

As shown in FIG. 4 and FIG. 5, this embodiment provides a photovoltaic module unit 100, which includes: a support frame 110, a photovoltaic module 120, and a light-transmitting load-bearing member 130. On this basis, the photovoltaic module unit 100 further includes an I-shaped steel 150. A bottom end of the I-shaped steel 150 is fixed to a cement road block 200, and a top of the I-shaped steel 150 is fixedly connected to a bottom of the support frame 110.

Preferably, a rubber pad 180 is provided between the top of the I-shaped steel 150 and a bottom bracket of the support frame 110. Skid resistance and shock resistance may be achieved and comfortability of running or walking on the rubber pad may be increased by paving the rubber pad 180 on the I-shaped steel 150. The support frame 110 is mounted on the rubber pad 180, and peripheries thereof are coated with weather-resistant sealant. Each photovoltaic module 120 is electrically connected by means of a junction box 121 and then is fixed by means of a wire clamp.

Preferably, the number of the I-shaped steels 150 is two, the two I-shaped steels 150 are perpendicular to one another, and a perpendicular intersection of the two I-shaped steels 150 is fixedly connected by means of an angle iron 170 and a fastener 190.

Further, either of the I-shaped steels 150 is provided with a wire passing hole 151. A lead wire obtained by connecting each of the photovoltaic modules 120 may be led out of the wire passing hole 151. The wire passing hole 151 also can play a role in weight reduction.

This embodiment further provides a ground photovoltaic power generation module photovoltaic device. As shown in FIG. 6, the ground photovoltaic power generation module photovoltaic device includes a plurality of photovoltaic module units 100 provided by the embodiment, and adjacent photovoltaic module unit 100 are fixedly connected to one another by means of a connecting piece. Specifically, adjacent photovoltaic module units 100 may be fixed to two sides of the rubber pad 180. There are a variety of arrangement modes of a plurality of photovoltaic module units 100, as long as they can satisfy use requirements. For example, a plurality of photovoltaic module units 100 are arranged in a straight line, or a plurality of photovoltaic module units 100 are arranged in a rectangular structure, or a plurality of photovoltaic module units 100 are arranged in a trapezoid structure.

The structure, features and effects of this embodiment are described above in detail based on the embodiments as shown in the figures, and the above embodiments are merely preferred embodiments of the present disclosure. However, the present disclosure does not limit the scope of implementation according to what is shown in the figures. Any modifications made in accordance with the conception of the embodiments or equivalent embodiments revised as equivalent changes shall fall within the scope of protection of the present disclosure as long as they are within the specification and the spirit covered by the drawings.

1. A photovoltaic module unit, comprising a photovoltaic module, and further comprising a light-transmitting load-bearing member and a support frame, wherein the support frame is used for supporting the photovoltaic module and the light-transmitting load-bearing member; and
the support frame comprises a first supporting plane and a second supporting plane, the first supporting plane is positioned above the second supporting plane, the light-transmitting load-bearing member is arranged on the first supporting plane, and the photovoltaic module is arranged on the second supporting plane.

2. The photovoltaic module unit according to claim 1, wherein:
the support frame comprises a lapping portion arranged on a side face of the support frame;
the first supporting plane is an upper surface of the support frame, and the second supporting plane is an upper surface of the lapping portion.

3. The photovoltaic module unit according to claim 1, wherein
a preset clearance is provided between the light-transmitting load-bearing member and the photovoltaic module.

4. The photovoltaic module unit according to claim 1, further comprising an I-shaped steel, wherein a bottom end of the I-shaped steel is fixed to a cement road block, and a top of the I-shaped steel is fixedly connected to a bottom of the support frame.

5. The photovoltaic module unit according to claim 4, wherein a rubber pad is provided between the top of the I-shaped steel and a bottom bracket of the support frame.

6. The photovoltaic module unit according to claim 4, wherein the number of the I-shaped steels is two, the two I-shaped steels are perpendicular to one another, and a perpendicular intersection of the two I-shaped steels is fixedly connected by means of an angle iron and a fastener.

7. The photovoltaic module unit according to claim 6, wherein either of the I-shaped steels is provided with a wire passing hole.

8. The photovoltaic module unit according to claim 1, wherein the light-transmitting load-bearing member is load-bearing glass.

9. The photovoltaic module unit according to claim 8, wherein the load-bearing glass is double-glazed laminated antiskid glass.

10. The photovoltaic module unit according to claim 9, wherein the bottom faces at two ends of the load-bearing glass are bonded and fixed to the top first supporting plane of the support frame by means of a structural adhesive.

11. The photovoltaic module unit according to claim 1, further comprising a protective side frame, wherein the protective side frame is arranged at two ends of the light-transmitting load-bearing member and the support frame, and the protective side frame is fixedly connected to the support frame by means of a bolt.

12. The photovoltaic module unit according to claim 1, wherein the support frame is made of aluminum alloy.

13. A ground photovoltaic power generation module photovoltaic device, comprising the a plurality of photovoltaic module units, wherein adjacent photovoltaic module units are fixedly connected to one another;
each of the photovoltaic module units comprises: a photovoltaic module, a light-transmitting load-bearing member, and a support frame; and
the support frame comprises a first supporting plane and a second supporting plane, the first supporting plane is positioned above the second supporting plane, the light-transmitting load-bearing member is arranged on the first supporting plane, and the photovoltaic module is arranged on the second supporting plane.

14. The photovoltaic device according to claim 13, wherein
the support frame comprises a lapping portion arranged on a side face of the support frame; and
the first supporting plane is an upper surface of the support frame, and the second supporting plane is an upper surface of the lapping portion.

15. The photovoltaic device according to claim 13, wherein a preset clearance is provided between the light-transmitting load-bearing member and the photovoltaic module.

16. The photovoltaic device according to claim 13, further comprising an I-shaped steel, wherein a bottom end of the I-shaped steel is fixed to a cement road block, and a top of the I-shaped steel is fixedly connected to a bottom of the support frame.

17. The photovoltaic device according to claim 16, wherein a rubber pad is provided between the top of the I-shaped steel and a bottom bracket of the support frame.

18. The photovoltaic device according to claim 17, wherein the number of the I-shaped steels is two, the two I-shaped steels are perpendicular to one another, and a perpendicular intersection of the two I-shaped steels is fixedly connected by means of an angle iron and a fastener.

19. The photovoltaic device according to claim 13, wherein the light-transmitting load-bearing member is double-glazed laminated antiskid glass.

20. The photovoltaic device according to claim 13, further comprising a protective side frame, wherein the protective side frame is arranged at two ends of the light-transmitting load-bearing member and the support frame, and the protective side frame is fixedly connected to the support frame by means of a bolt.
